(19) United States
(12) Patent Application Publication
(10) Pub. No.: US 2005/0288923 A1
(43) Pub. Date: Dec. 29, 2005

(54) Speech enhancement by noise masking

(75) Inventor: Chi-Wah Kok, Hong Kong (CN)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: THE HONG KONG UNIVERSITY OF SCIENCE AND TECHNOLOGY, Hong Kong (CN)

(21) Appl. No.: 10/875,695

(22) Filed: Jun. 25, 2004

(51) Int. Cl. G10L 21/02

(52) U.S. Cl. 704/226

(57) ABSTRACT

The invention provides a method and apparatus for noise reduction of a signal, for example speech enhancement of a speech signal. The method involves a two-stage algorithm comprising performing a preprocessing first spectral subtraction to remove tonal noise and generate a tonal noise removed signal, and performing a second spectral subtraction to remove noise from the said tonal noise removed signal. In both spectral subtraction stages noise is not removed completely but only to a level below an audible threshold in order to avoid unwanted artifacts.

### FIELD OF THE INVENTION

This invention relates to a method and apparatus for noise reduction, and in particular to a method and apparatus that make use of a novel speech enhancement apparatus to reduce the noise in an input speech signal.

### BACKGROUND OF THE INVENTION

Speech enhancement is an algorithm that makes the human voice clearer and easier to understand. Speech enhancement is a special case of time-varying signal estimation. The speech enhancement algorithm finds an optimal estimate preferred by a human listener. Since the human ear is the final judge, and it does not believe in a simple mathematical error criterion, speech signals are estimated by modeling the speech production or the perceptual mechanism of humans. In comparison, the noise spectrum is relatively easier to estimate than that of the speech signal, because the noise component is relatively stationary. Since the speech signal is assumed to be corrupted by additive noise, therefore, clean speech can be obtained by a spectral subtraction technique [S. F. Boll, “Suppression of acoustic noise in speech using spectral substraction,” IEEE Trans. Acoustics, Speech, Signal Processing, pp. 113-120, April 1979.] with the estimated noise spectrum.

Since the development of this spectral subtraction method, a number of variants have been developed to provide better speech enhancement through different noise signal spectrum estimation methods. Through advanced estimation techniques, clean speech can be generated with the entire noise component being removed. Unfortunately, spectral subtraction introduces artifacts into the clean speech at the same time which can be very annoying and unnatural.

The most annoying artifact associated with spectral subtraction is the musical noise. The musical noise is caused by the variance in the magnitude of the cleaned speech spectra and consists of short isolated tone bursts distributed across the spectrum. Various techniques have been developed to reduce the artifacts associated with spectral subtraction techniques, and recently auditory masking has been used to improve the quality of noise reduction algorithms. Instead of attempting to remove all noise from the signal, these algorithms attempt to attenuate the noise below the audible threshold. This reduces the amount of modification to the spectral magnitude and thus reduces artifacts.

An auditory model is used in N. Virag, “Single channel speech enhancement based on masking properties of the human auditory system,” IEEE Trans. Speech and Audio Processing, vol. 7, pp. 126-137, March 1999 to adjust the parameters of a non-auditory noise suppression procedure. Haulick et al [T. Haulick, K. Linhard, and P. Schrogmeier, “Residual noise suppression using psychoacoustic criteria,” Proc. Euruspeech 97, pp. 1395-1398, September 1997.] uses the auditory masking threshold to identify and then suppress musical noise. Thiemann et al [J. Thiemann and P. Kabal, “Noise Suppression using a Perceptual Model for Wideband Speech Signals,” Proc. Biennial Symposium on Communications, pp. 516-519, June 2002.] directly constructed the spectral subtraction levels from a high-resolution psychoacoustic model originally developed for the evaluation of audio quality. High quality clean speech can be produced, however, the algorithm does not work well on noisy speech obtained from environments with tonal noise nature, such as existing of background speech, static noise, etc. In that case, not only is more non-white residual noise and musical noise audible in the output, but also a lowpass filtering effect is observed.

The problems with the prior art are caused by inaccurately calculated masking parameters that enhance the artifacts instead of suppressing them. Tonal noise cannot be suppressed by a simple noise masking, technique. To obtain clean speech, over-estimated noise components are used, which on the other hand will lead to musical noise.

### SUMMARY OF THE INVENTION

It is an object of the invention to provide a novel method for speech enhancement that aims to provide a tonal noise suppression scheme that is shown to work well with the auditory noise masking speech enhancement system and which will overcome or at least mitigate the drawbacks with the prior art. Furthermore, a relatively simple and computational efficient algorithm is proposed to compute the auditory mask.

According to the present invention there is provided a method of noise reduction of an input signal comprising performing a preprocessing first spectral subtraction to remove tonal noise and generate a tonal noise removed signal, and performing a second spectral subtraction to remove noise from the said tonal noise removed signal.

In a preferred embodiment the preprocessing first spectral subtraction comprises identifying tonal noise from the power spectrum of said input signal. Preferably this is achieved by subtracting identified tonal noise from the magnitude response of the input signal, but could equally be performed by subtracting from the energy response.

In a preferred embodiment the second spectral subtraction includes non-linear filtering of the tonal noise removed signal using a noise suppression gain factor. The noise suppression gain factor may be obtained by estimating the noise spectrum of said tonal noise removed signal. If the input signal is a speech signal, then the noise spectrum may be estimated by detecting speech pauses using a voice activity detector. Preferably the estimated noise spectrum is shaped in accordance with the human auditory response, preferably to provide an overestimation of the noise in a desired frequency range (eg 3-4 kHz).

Most preferably the second spectral subtraction comprises removing noise only to a level below the audible threshold and not removing all noise entirely. Similarly the first tonal noise subtraction comprises removing tonal noise only to a level below the audible threshold that results in a locally smooth spectral responses and not removing all the tonal noise entirely.

For convenience of signal processing the input signal may be divided into segmented windows for processing. The first and second spectral subtractions may be performed dynamically in real-time, or may be performed offline.

Preferably the input signal is a noisy speech signal.

According to another broad aspect the present invention also provides apparatus for noise reduction of an input signal comprising, means for performing a preprocessing first spectral subtraction to remove tonal noise and for generating a tonal noise removed signal, and means for performing a second spectral subtraction to remove noise from the said tonal noise removed signal.

### BRIEF DESCRIPTION OF THE DRAWINGS

An embodiment of the invention will now be described by way of example and with reference to the accompanying drawings, in which:—

FIG. 1 shows a block diagram of an algorithm according to an embodiment of the invention,

FIGS. 2a and 2b show the spectral response of a test signal obtained before (a) and (b) after noise reduction using a method according to an embodiment of the invention,

FIGS. 3a and 3b show spectrograms of noisy (a) and clean (b) speech obtained using an embodiment of the invention,

FIG. 4 illustrates the spectral response of a frame obtained from a sample using an embodiment of hic present invention,

FIG. 5 illustrates the application of an embodiment of the present invention to a cellular telephone, and

FIG. 6 illustrates the application of an embodiment of the present invention to a hearing aid.

### DETAILED DESCRIPTION OF PREFERRED EMBODIMENT

Proposed Algorithm

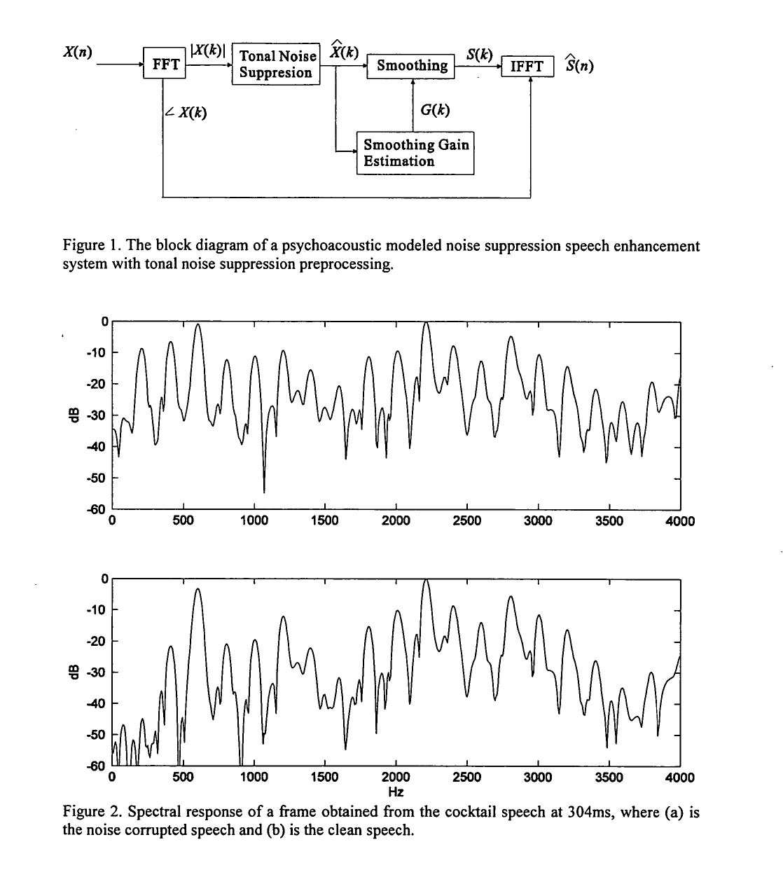

The speech signal sampled at f=8000 Hz, and grouped into subframes of 16 ms, or 128 samples. A processing frame is formed by two adjacent subframes and is sample-by-sample multiplied to the raised-cosine window

$$h ( n ) = 0.54 - 0.46 cos ( \frac{2 π n}{N - 1} ) , \qquad ( 1 )$$

where N=256 is the frame size. Notice that the processed frame can be perfectly reconstructed to the original speech signal through an overlap add process. The high-resolution spectral response X(k) of the windowed signal is computed using a 1024 point DFT. The magnitude response |X(k)| is preprocessed to suppress tonal noise, while the phase ∠X(k) is reserved for the reconstruction of the noise suppressed signal. A perceptually modeled noise mask is then used to nonlinearily filter the tonal noise suppressed signal \hat{X}(k) to generate the magnitude response of the clean speech Ŝ(k). The clean speech is obtained by the IDFT of the signal Ŝ(k)·∠X(k). FIG. 1 shows the detail block diagram of the proposed algorithm.
Tonal Noise Suppression

The tonal analysis method described in MPEG1 audio coder was followed to detect tonal component from the power spectrum P(k,p) of the high resolution spectrum |X(k,p)| of the p-th speech signal frame of the noise corrupted signal x(n,p), where

$$P ( k , p ) = 20 \cdot {log}_{10} ( \frac{\vert X ( k , p ) \vert}{1024} ) . \qquad ( 2 )$$

The power spectrum P(k,p) is normalized through a reference level of 96 dB as
P(k,p)=P(k,p)−max(P(k,p))+96. (3)
Tonal signal (both speech and noise) are detected by first locating the peaks of P(k,p). A located spectral peak is considered to be a tonal component if and only if it has large enough amplitude when compared to its neighbors. The amplitude threshold for the tonal component is adjusted according to the spans s of the neighbors used in the comparison, such that the spectral location k contains a tonal component if and only if

$$X ( k , p ) is tonal ↔ \{ \begin{matrix}P ( k ) - P ( k + s ) > {t}_{s} . \\ P ( k ) - P ( k - s ) > {t}_{s} .\end{matrix} \qquad ( 4 )$$

To determine the tonal component to be speech or noise, the algorithm relies on the relative stationary nature of the noise signal within each windowed period when compared to that of the speech signal in the same windowed period. A moving window estimator for tonal noise is applied which employs a counter to monitor the tonal components. Furthermore, in order to combat for the chaotic nature of the tonal components in real world applications, the spectrum is divided into 40 bands such that each band contains two frequency bins. One counter is assigned to each band, and the counter will be increased by one whenever a tonal component is detected in that particular band. Otherwise the counter will be decreased by one. When the counter values exceed a chosen threshold, the detected tonal signal at the associated frequency bin is considered to be tonal noise and is suppressed by replacing |X(k,p)| with the geometric mean of the spectral components around |X(k,p)|.

$$\vert \hat{X } ( k , p ) \vert = {( {\prod }_{t = - 7}^{7} \vert X ( k + i , p ) )}^{\frac{1}{15}} \qquad ( 5 )$$

For all other frequencies, |\hat{X}(k,p)|32|X(k,p)|.
Voice Activity Detector

The noise spectrum W(k,p) is estimated from the tonal noise suppressed signal |\hat{X}(k,p)|. The estimate of the noise is taken from the speech pauses which are identified using a voice activity detector given by

$$V = \frac{1}{N} [ \frac{{\vert \hat{X} ( k , p ) \vert}^{2}}{{\vert W ( k , p - 1 ) \vert}^{2}} - log \frac{{\vert \hat{X} ( k , p ) \vert}^{2}}{{\vert \tilde{W } ( k , p - 1 ) \vert}^{2}} - 1 ] , \qquad ( 6 )$$

where W(k,p−1) is the estimated noise power spectrum in the p-1-th frame. The p-th frame is determine to be speech or noisy by

$$V \begin{matrix}> 0.6 speech , \\ < 0.6 noise .\end{matrix} \qquad ( 7 )$$

Since the spectrum of the noise signal is assumed to be a short-time stationary process, therefore, the noise power spectrum is updated from the current and previous estimates according to
|W(k,p)|²=λ|W(k,p−1)|²+(1−λ)|\hat{X}(k,p)|², (8)
where λ is the noise forgetting factor, and is chosen to be 0.7 in the simulation. Since the p-th frame is determined to be a noise frame, therefore, \hat{X}(k,p) is the current noise estimate. Otherwise, if the p-th frame is determined to be speech frame, then |W(m,p)|²=|W(m,p−1)|².
Nonlinear Filtering

The speech is cleaned by nonlinear filtering using Wiener filter. G(k,p) for the k-th frequency bin in the p-th frame. Such that the clean noise is given by
S(k,p)=|\hat{X}(k,p)|G(k,p)·∠X(k,p), (9)
where G(k,p) is given by the Wiener filter of the tonal suppressed signal as

$$G ( k , p ) = \frac{\vert \hat{S} ( k , p ) \vert}{\vert \hat{X} ( k , p ) \vert} , \qquad ( 10 )$$

where Ŝ(k,p) is the estimation of the clean speech signal obtained by
|Ŝ(k,p) ²=max(|\dot{X}(k,p)|²−|W(k,p)|², 0), (11)
with W(k,p) being the estimated noise in previous frame. To combat for the time-varying property of the speech signal, the noise suppression gain factor G(k,p) is computed as weighted average with the noise suppression gain factor at frame p−1, and gives smoothed noise suppression gain factor Ĝ(k,p) as
Ĝ(k,p)=0.3G(k,p−1)+(1-0.3)G(k,p), (12)
and eq. (9) is modified to use Ĝ(k,p) instead of G(k,p). To avoid unnatural speech reproduction, a noise floor is set to avoid dead-air in the reproduced clean speech signal
Ĝ(k,p)=max(Ĝ(k,p),0.05). (13)
Psychoacoustic Modeled Noise Masking

To reduce artifacts, the estimated noise spectrum W(k,p) is shaped according to the human auditory response
Ŵ(k,p)=W(k,p)(0.85+1.8e^{-0.45}k) (14)
where the shaped noise Ŵ(k,p) will be used to replace W(k,p) in eq. (8). There are two reasons for the above noise shaping. Firstly, any tonal noises that are not suppressed will be detected by human ear, and human ears are most sensitive in the frequency range of 3-4 kHz. Shaping the noise to provide an overestimation in that frequency range will reduce residual noise problems associated with spectral subtraction. Secondly, discontinuities of spectrum at high frequency are observed after nonlinear filtering due to inaccurate noise spectrum estimation. Such discontinuities will result in ripples in the time domain waveform of the clean speech signal according to Gibbs phenomena. Such ripples are observed as musical noise in the reconstructed signal. As a result, the de-emphasis of the high frequency noise estimate in the shaped noise helps to reduce the discontinuity problem and thus reduces musical noise.

To further reduce the artifacts, not all the noise powers are removed from the tonal noise suppressed speech signal. Instead it is suppressed to a level smaller than the audible threshold obtained from the psychoacoustic model. In this case, because a relatively small amount of signal is induced in the nonlinear filtering procedure this reduces the amount of artifacts induced into the clean speech. A psychoacoustic noise suppression threshold can be computed by modifying eq. (10) as

$$\hat{G} ( k , p ) = \frac{PE ( \hat{S} ( k , p ) )}{PE ( \hat{X} ( k , p ) )} , \qquad ( 15 )$$

where PE( ) is the perceptual model.

The following simulation applied the perceptual model used by MPEG-1 audio coding which is discussed in W. Zwickcr and H. Fastl, Psychoacoustics, Springer Verlag, 1999.

Simulation Results

The performance of the proposed speech enhancement algorithm of an embodiment of the present invention as evaluated on the “Aurora 2 database [AU/378/01, “SpeechDat-Car Digits Database for ETSI STQ-Aurora Advanced DSP”, Aalborg University, January 2001]. The Aurora 2 database provides a set of digital sequences recorded under different conditions (driving, cockpit, cocktail and street). As a result, the speech signal in Aurora 2 database spans a wide spectrum of signal to noise ratios. At the same time, clean samples are also provided. Informal listening tests have shown that the proposed algorithm works very well in almost all conditions, and works well in all conditions when compared to traditional spectral subtraction algorithm. When compared to conventional speech enhancement algorithms using auditory masking, fewer audible artifacts are detected in the enhanced speech. This is especially true for musical noise artifacts, where the new algorithm which employs tonal removal algorithm effectively reduced the amount of musical noise in the cleaned speech.

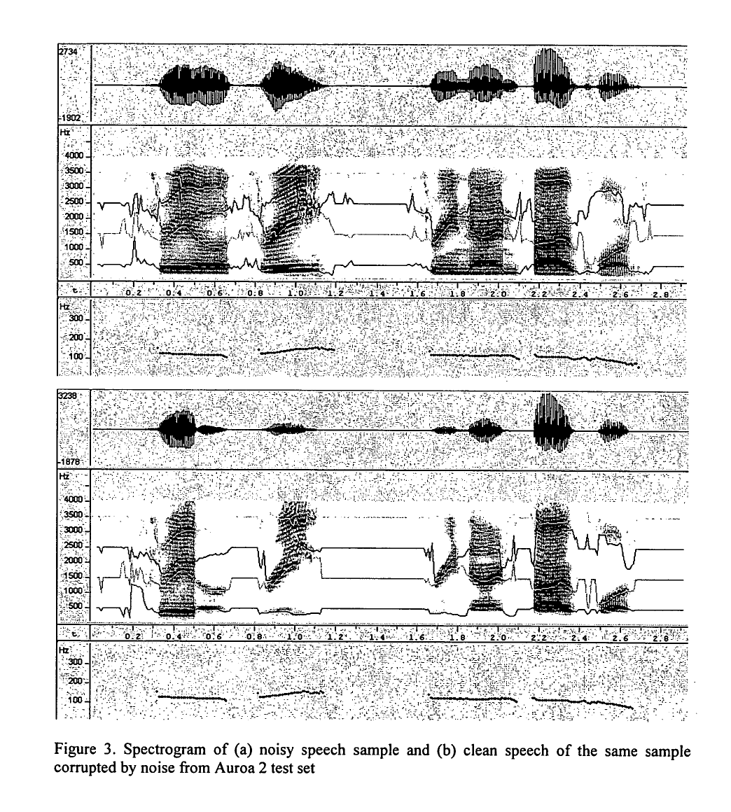

Shown in FIGS. 3a and 3b are the spectrogram of the noisy and the cleaned speech using the proposed algorithm of test sample 503 in the Aurora 2 test set (which is recorded in a cocktail environment with a number of speakers speaking in the background). It can be observed that the spectral peaks of the two waveforms are almost the same. As a result, the cleaned speech sounds the same as the noisy speech but with most of the noise removed as shown by the much clear spectrogram.

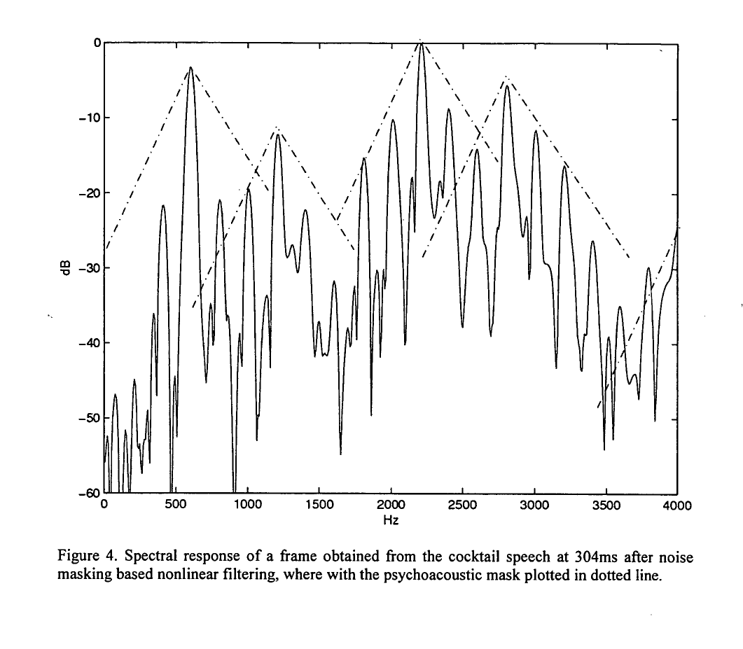

Shown in FIGS. 2a and 2b are the spectral response of a test sample obtained before and after the proposed speech enhancement algorithm, which clearly show that the noisy tonal components are not completely removed. Instead they are suppressed to a level lower than the audible threshold obtained from the psychoacoustic model as shown in FIG. 4, where the dotted lines are the audible threshold resulted from the tonal masking effects of the psychoacoustic model. Notice that by suppressing the tonal noise and other noise components to a level smaller than the audible threshold value it is possible to efficiently clean the noisy speech and at the same time reduce the amount of artifacts induced into the clean speech. For all and a very large number of simulations, high quality clean speech are obtained and all of them are free from musical noise effects which are observed in other speech enhancement algorithms.

It will thus be seen that, at least in its preferred forms, the present invention provides a speech enhancement algorithm that works well when both narrowband and wideband speech signals are presented. The proposed algorithm makes use of nonlinear Wiener filtering to suppress noise in speech signal. A simple but efficient psychoacoustic noise spectral mask computation algorithm is proposed. The computed noise spectral mask is applied to construct the Wiener filter. When compared to the traditional noise subtraction technique which subtracts an overestimated noise component from the noise corrupted speech signal to combat for the time variation property of the noise signal, the proposed algorithm does not completely remove the noise component from the noisy corrupted speech signal. Therefore it is considered to induce less distortion to the clean speech signal and thus achieve better performance than that of the traditional spectral subtraction technique. The incorporation of tonal noise removal components into the speech enhancement system provides a more accurate estimation of the psychoacoustic model and thus achieves better noise suppression results. The speech enhancement system with tonal noise suppression is shown to be able to provide clean speech that outperforms other systems with similar complexity.

It will be readily understood by a skilled man that the abovedescribed methods for noise reduction can be embodied in apparatus in a number of conventional ways. For example the algorithm can be written as software which may be stored in the processing means of a sound processing device. The noise reduction is preferably carried out dynamically in real-time, for example when incorporated as part of an earpiece for, for example, a hearing aid. In addition, however, the noise reduction could also be performed “off-line” using a previously stored digital file.

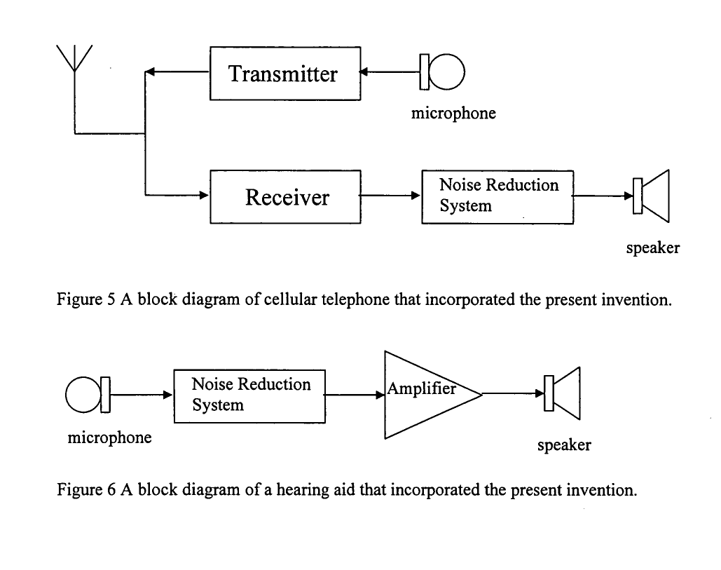

FIG. 5 is an example of a first practical embodiment of the invention in which the noise reduction method and system of the present invention is incorporated into a cellular telephone. The received audio signal of the cellular telephone is cleaned by an embodiment of the present invention before being presented to the user. The present invention will therefore clean the audio signal received from the RF front end of the cellular telephone which results in an audio signal that is free from humming noise, echo, and other kinds of background noises. FIG. 6 is an illustration in block diagram form of a digital hearing aid in accordance with an embodiment of the present invention. The present invention will therefore clean the audio signal received by the microphone of the hearing aid which results in an audio signal that is free from echo noises resulted from positive feedback, and other kinds of background noises. It also provides a clean voice signal that is suitable for further amplification before being presented to the user.

1. A method of noise reduction of an input signal comprising performing a preprocessing first spectral subtraction to remove tonal noise and generate a tonal noise removed signal, and performing a second spectral subtraction to remove noise from the said tonal noise removed signal.

2. A method as claimed in claim 1 wherein said preprocessing first spectral subtraction comprises identifying tonal noise from the power spectrum of said input signal.

3. A method as claimed in claim 2 wherein said first spectral subtraction includes subtracting identified tonal noise from the magnitude response of the input signal.

4. A method as claimed in claim 1 wherein said second spectral subtraction includes non-linear filtering of the tonal noise removed signal using a noise suppression gain factor.

5. A method as claimed in claim 1 wherein said noise suppression gain factor is obtained by estimating the noise spectrum of said tonal noise removed signal.

6. A method as claimed in claim 5 wherein said input signal is a speech signal and said noise spectrum is estimated by detecting speech pauses using a voice activity detector.

7. A method as claimed in claim 5 wherein said estimated noise spectrum is shaped in accordance with the human auditory response.

8. A method as claimed in 7 where the estimated noise spectrum is shaped in accordance with the human auditory response to provide an overestimation of the noise in a desired frequency range.

9. A method as claimed in claim 8 wherein said desired frequency range is 3-4 kHz.

10. A method as claimed in claim 1 wherein said second spectral subtraction comprises removing noise only to a level below the audible threshold and not removing all noise entirely.

11. A method as claimed in claim 1 wherein input signal is divided into segmented windows for processing.

12. A method as claimed in claim 1 wherein said first and second spectral subtractions are performed dynamically in real-time.

13. A method as claimed in claim 1 wherein said first and second spectral subtractions are performed offline.

14. A method as claimed in claim 1 wherein said signal is a speech signal.

15. A method as claimed in claim 3 wherein said tonal noise subtraction comprises removing tonal noise only to a level below the audible threshold that results in a locally smooth spectral responses and not removing all the tonal noise entirely.

16. A method as claimed in claim 15 where said estimated audible threshold is shaped in accordance with the human auditory response.

17. A method as claimed in claim 15 where said estimated locally smooth spectral responses is obtained through spectral interpolation.

18. Apparatus for noise reduction of an input signal comprising, means for performing a preprocessing first spectral subtraction to remove tonal noise and for generating a tonal noise removed signal, and means for performing a second spectral subtraction to remove noise from the said tonal noise removed signal.

19. Apparatus as claimed in claim 18 wherein said means for performing a preprocessing first spectral subtraction comprises means for identifying tonal noise from the power spectrum of said input signal.

20. Apparatus as claimed in claim 19 wherein said means for performing a preprocessing first spectral subtraction comprises means for subtracting identified tonal noise from the magnitude response of the input signal.

21. Apparatus as claimed in claim 18 wherein said second spectral subtraction means includes non-linear filter means using a noise suppression gain factor.

22. Apparatus as claimed in claim 21 wherein said second spectral subtraction means includes means for obtaining said noise suppression gain factor by estimating the noise spectrum of said tonal noise removed signal.

23. Apparatus as claimed in claim 22 comprising a voice activity detector for detecting speech pauses in an input speech signal.

24. Apparatus as claimed in claim 22 wherein the noise spectrum is shaped in accordance with the human auditory response.

25. Apparatus as claimed in claim 24 wherein the estimated noise spectrum is shaped in accordance with the human auditory response to provide an overestimation of the noise in a desired frequency range.

26. Apparatus as claimed in claim 18 wherein said second spectral subtraction means functions to remove noise only to a level below the audible threshold and does not remove all noise entirely.
